(19) United States
(12) Patent Application Publication
(10) Pub. No.: US 2024/0318322 A1
(43) Pub. Date: Sep. 26, 2024

(54) SYSTEM FOR CARRYING OUT ELECTROLYSIS

(71) Applicant: H2i GreenHydrogen GmbH, Wallern an der Trattnach (AT)

(72) Inventors: Dietmar NEUBACHER, Graz (AT); Sebastian GOTTHARDT, Graz (AT)

(73) Assignee: H2i GreenHydrogen GmbH, Wallern an der Trattnach (AT)

(21) Appl. No.: 18/574,229

(22) PCT Filed: Jun. 29, 2022
(86) PCT No.: PCT/AT2022/060229

§ 371 Date: Dec. 26, 2023

(30) Foreign Application Priority Data
Jul. 1, 2021 (AT) A50550/2021

(51) Int. Cl. C25B 1/04; C25B 9/19; C25B 9/70; C25B 15/021; C25B 15/027; C25B 15/08

(52) U.S. Cl. CPC C25B 1/04; C25B 9/19; C25B 9/70; C25B 15/021; C25B 15/027; C25B 15/087

(57) ABSTRACT

The disclosure relates to a system for carrying out electrolysis to produce oxygen and hydrogen. Said system comprises at least two electrolysis devices, and these electrolysis devices can be supplied with an electrolyte by a common electrolyte supply device. Furthermore, these electrolysis devices each have an electrolyte inlet and an electrolyte outlet, which electrolyte inlets and electrolyte outlets are coupled to the common electrolyte supply device to provide an electrolyte stream through each of the electrolysis devices. The system also comprises at least one electronic control device and at least one flow state detection device to detect the flow states of the electrolyte stream through at least one of the electrolysis devices. The control device is designed to control at least one actuator to influence the electrolyte stream through at least one of the electrolysis devices using detection values from the at least one flow state detection device.

The invention relates to a system for carrying out electrolysis to produce oxygen and hydrogen, as disclosed in the claims. The system is intended for a flexible design of the electrolysis process for producing oxygen and hydrogen with simultaneously high efficiency and/or an extended service life of the individual components of the system.

In EP1866996B9, a system consisting of one or more electrolysis cell subsystems and one or more fuel cell subsystems and one or more liquid modules is presented, which system may be expanded with regard to the one or more fuel cell subsystems or the one or more electrolysis cell subsystems. In this system, at least one or more electrolytic cell subsystems are in fluidic and electrical communication with at least one or more liquid modules, wherein the fluidic and electrical communication connections of the system are not limited to a specific number. Furthermore, a control means is described which activates or monitors or adjusts or deactivates all aspects of the connection between the functional parts of the system, in particular between subsystems and fluid modules. The control means is intended to detect fluctuations in individual functional parts of the system during operation and to automatically compensate for such fluctuations directly and/or indirectly, making it possible to use subsystems with different technologies or from different manufacturers or of different types. Furthermore, the control means is intended to allow the system to be transferred to a maintenance mode in which a modular replacement process of subsystems of the system may be carried out. However, the usability and operating ergonomics of this well-known system are only partially satisfactory.

CN111826669A describes a system with electrolysis devices in a modular design. The system shows a modularization related to the repeated construction of electrolysis devices, wherein these electrolysis devices in turn include several electrolysis modules, these electrolysis modules having different power ranges. In this system, the electrolyte supply is configured separately for each electrolysis module. With regard to the supply of electrolyte, the usability of the electrolysis modules and the operating ergonomics of this system are only partially satisfactory.

The object of the present invention is to overcome the disadvantages of the prior art and to provide an electrolysis system in which the structure and the process of electrolysis for generating oxygen and hydrogen are improved.

This object is solved by a system for carrying out electrolysis to produce oxygen and hydrogen in accordance with the claims.

The system according to the invention comprises at least two electrolysis devices, which electrolysis devices may be supplied with an electrolyte from a common electrolyte supply device, wherein the at least two electrolysis devices each have an electrolyte inlet and an electrolyte outlet, which electrolyte inlets and electrolyte outlets are fluidically coupled to the common electrolyte supply device to provide an electrolyte stream through each of the electrolysis devices, and at least one electronic control device. It should be noted at this point that, for the sake of readability, the term electrolyte used includes both media that are considered electrolytes and alcohols or ultra-pure water. At least one flow state detection device is configured to detect the flow states of the electrolyte stream through at least one of the electrolysis devices. The control device is designed to control at least one actuator to influence the electrolyte stream through at least one of the electrolysis devices using detection values from the at least one flow state detection device.

Such a system is particularly practicable because the electrolytic production of oxygen and hydrogen may be carried out in an improved manner by an electrolysis device using an electrical power specified for the system with the aid of the flow state detection device with the control device by the actuator for influencing the electrolyte stream with regard to the electrolysis process. In particular, optimum process control is made possible by the disclosed system even if the specified electrical power for maintaining the electrolysis is not kept constant. In such cases, the electrolyte stream may be adapted by the actuator in a simple yet effective way to optimize the supply of the electrolysis devices. With regard to the optimum supply of the electrolysis devices, the detection values of the flow state detection device are used to draw conclusions about the operating state of the electrolysis devices and thus subsequently to detect deteriorations or changes in the electrolysis process of the electrolysis device at an early stage and to be able to counteract these in terms of control technology. This state monitoring based on the flow state detection device is also advantageously designed to be able to reliably and easily detect gradual process-related changes, such as degradation of chemically active materials that contribute to the electrolysis process or insufficient chemical reactivity of the electrolysis devices, within a longer observation period, in particular over several hours, several days or several months, by evaluating detection values.

The disclosed configuration of the system is particularly advantageous because at least two electrolysis devices may be supplied with an electrolyte from a common electrolyte supply device. Apart from the structural and technical advantages of a common supply by the electrolyte due to a reduced number of individual components, the electrolysis process may be precisely controlled with regard to an optimum electrolyte stream for the electrolysis devices to be supplied by influencing the electrolyte stream through the configuration of the system according to the claims with at least one flow state detection device with control device and actuator. This means that the size and supply capacity of the shared electrolyte supply device does not have to be directly matched to the electrolysis devices. Detection of flow states and reactions derived or initiated by the control device, which are executed or implemented via the actuator, enables the electrolysis devices to be supplied according to their requirements. It is also advantageous that the electrolysis devices are protected against insufficient or excessive electrolyte stream. The electrolyte stream through the individual electrolysis devices may be controlled by the configuration of the system according to the claims with regard to the process, thus increasing the operational reliability and functional availability of the electrolysis process and the entire system. Therefore, the electrolyte supply device may also be configured to be inherently redundant and/or oversized for the respective system, for example with regard to the fluidic pressure ranges or flow rates, wherein the protection of the implemented electrolysis devices is still guaranteed by the technical features according to the claims.

The electrolyte supply device is thus configured independently of the electrolysis devices with regard to the supply capacity of the electrolyte supply device, which occurs as a mutually decoupled interaction and brings further far-reaching advantages of the system. In addition to the number of electrolysis devices used, the technological configurations or the designs of the electrolysis device used may also vary with regard to the electrolysis process for different systems and yet an identical or uniform electrolyte supply device may be used for such diversely designed systems. This advantage is particularly economical, as variants of different systems are possible with the same electrolyte supply device, which different systems are used specifically for different specified power ranges.

Another advantageous embodiment is one according to which it may be provided that the at least two electrolysis devices are structurally designed differently, with the different structural design of the electrolysis devices resulting in different operating ranges with regard to the electrical power of the electrolysis devices. This design makes it possible to implement more specific requirements for different operating strategies and thus an extended use of the system. By way of example, a first electrolysis device with a first operating range is used in a first range of electrical power, which is higher relative to a second electrolysis device, in order to utilize a base electrical load, which is constant over a first period of time, for the electrolytic generation of oxygen and hydrogen; whereas the second electrolysis device is used in a second operating range in order to utilize peak electrical loads, which additionally occur over a second period of time, for the electrolytic generation of oxygen and hydrogen. Overall, the total efficiency of the system is thus increased over a period of time with repeatedly changing electrical load profiles, as the electrolysis devices work or are operated in their respective optimum operating or load range thanks to the structural measures mentioned.

A further advantage of this design is that the second electrolysis device with a second operating range may be converted into an idle mode or standby mode, in particular a rinsing mode for any peak load that may occur with a minimum electrolyte stream, by means of the interaction of the flow state detection device, the control device and the actuator during operation to cover a base electrical load, thus ensuring the power readiness of the second electrolysis device, which increases the reaction speed for providing control services by a connected electrical power grid to provide the electrical power.

An embodiment of the system with electrolysis devices with different operating ranges in terms of electrical power is particularly advantageous, as the fluidic interaction between different electrolysis devices in terms of their electrical power and the one actuator is utilized to influence the electrolyte stream when a new operating point of the system is reached. Since the provision of electrolyte at the electrolysis devices is delayed compared to the provision of electrical power at the electrolysis devices due to the inertia of the electrolyte, a short-term lower total efficiency of the system is counteracted by a predictive control of the actuator on the basis of the detection values of the flow state detection device, taking into account the required electrolyte stream for the respective electrolysis devices. When operated to provide regulation services with frequent coverage of peak loads, a significantly higher total efficiency of the system is thus achieved over a longer operating time, which makes the disclosed system particularly suitable as an energy storage power plant with regulation capacities for the electrically connected power grid.

According to a further embodiment, it is conceivable that the at least two structurally different electrolysis devices are fluidically connected in parallel with regard to the inflowing and outflowing electrolyte stream. This advantageous design of the system means that each of the at least two electrolysis devices may be supplied directly with electrolyte from the electrolyte supply device. In connection with the detection values determined by the at least one flow state detection device and a control of the electrolyte stream by the at least one actuator based thereon, this results in a precise controllability of the system, in particular if the electrical connection of the at least two electrolysis devices is designed in a parallel, serial or interchangeable form. Since changing requirements for the electrolyte stream from and/or to the at least two electrolysis devices arise in particular when the electrical connection is changed from electrical parallel connection to series connection of the electrolysis devices, or in reverse order, as a result of the change in the electrolysis process within the electrolysis devices, each of the at least two electrolysis devices may be optimally or appropriately supplied with electrolyte by means of the determined detection values via the control of the at least one actuator on the basis of the fluidic parallel connection; this is in particular because the fluidic parallel connection within the electrolyte stream results in fluidically communicating feedback effects in the electrolyte stream due to the change in the electrolysis process, which can be clearly detected by the flow state detection device and subsequently at least partially compensated or equalized by the at least one actuator, in particular by at least one electromechanical valve. A further advantage is that electrolysis devices, which have or cause different dynamic pressures in relation to the electrolyte streams due to their design and/or gradual changes in process parameters, may be optimized and operated as fail-safe as possible.

According to an advantageous further embodiment, it may be provided that each of the electrolysis devices is assigned a flow state detection device for detecting the electrolyte stream through the individual electrolysis devices. This makes it possible to optimally adjust the electrolyte stream through the respective electrolysis device by means of the at least one actuator during operation of the at least two electrolysis devices on the basis of the detection values of the flow state detection devices for each of the at least two electrolysis devices. At the same time, feedback by the detection values from the flow state detection devices regarding the electrolyte stream is used to ensure operational safety. In particular, the ability to detect a faulty operating behavior of each of the at least two electrolysis devices is provided. A further advantageous effect of this further embodiment is that the electrolyte stream is adjusted with the at least one actuator in a specific manner, i.e. adapted to each of the at least two electrolysis devices, particularly during transient operation of the at least two electrolysis devices. This is particularly advantageous if, due to the demands placed on the system by a power supply grid that changes over time, the load requirements on the at least two electrolysis devices are different and vary over time and the actuator is controlled accordingly to buffer accelerations or decelerations of the electrolyte stream while continuing to operate in the optimum operating range. A further advantage of this further embodiment is that pulsations of the electrolyte stream induced by the at least one actuator may be used in a targeted manner, which favors gas bubble detachment from the components limiting the electrolyte, while at the same time ensuring operational safety based on the detection values of the flow state detection devices for the individual electrolysis devices. This improved gas bubble detachment from components adjacent to the electrolyte increases the total efficiency of the system, as the reactivity of electrochemically active surfaces in the electrolysis devices is increased.

Furthermore, it may be expedient for the control device to be configured to control the at least one actuator using the detection values of the at least one flow state detection device in such a way that each of the electrolysis devices is operated within its respective predefined volume flow operating range. This design of the invention has the advantage that the electrolyte stream through the respective electrolysis devices is adapted in accordance with the specific flow resistances of the electrolysis devices in such a way that an optimum flow through the electrolysis device is ensured in terms of the electrolysis process, while at the same time component protection, in particular overload protection with regard to electrolyte pressures, is ensured within the respective predefined volume flow operating range. A further effect of this design is the possibility of individual reaction to an operational load of an electrolysis device and thus the possibility of individual regulation of the respective electrolyte stream within the respective predefined volume flow operating range for each of the electrolysis devices, in order to react to operational requirements for the process heat within an electrolysis device on the one hand to ensure or increase operational safety and on the other hand to ensure a high degree of efficiency of the respective electrolysis device. In addition, this design allows the advantageous effect of gentle operation with regard to service life to be realized through an optimum electrolyte volume flow in idle mode.

According to an appropriate embodiment, the flow state detection device may comprise at least one pressure sensor. This makes it possible for the electrolyte volume flow to be detected with high temporal resolution, which means that the electrolyte stream through the at least two electrolysis devices may be adapted particularly quickly with regard to a transient mode of operation of the electrolysis devices and the resulting pulsations by means of the at least one actuator. With regard to the operational safety of the system, this also has the advantageous effect that the pressure of the electrolyte may also be monitored by the flow state detection device and that the at least one actuator may react directly to safety-critical operating points or threshold values of the at least two electrolysis devices. In addition, the ability to detect the flow speed of the electrolyte more precisely via a pressure measurement of the at least one pressure sensor has the advantage that the convective heat transport for a targeted temperature regulation of the at least two electrolysis devices may be optimally adjusted by means of the actuator. In terms of construction, the use of at least one pressure sensor has the advantage that this at least one pressure sensor is relatively inexpensive with high measuring accuracy, especially in comparison to volume flow sensors.

In addition, it may be provided that the flow state detection device comprises at least one temperature sensor, which is particularly advantageous with regard to the detection of the quantities of heat absorbed or released by the electrolyte from the at least two electrolysis devices. Thus, by regulating the electrolyte stream by means of the at least one actuator, an optimum or predetermined process temperature for the at least two electrolysis devices is possible or may be set. In addition to the high efficiency of an electrolysis device in operation, this has the further positive effect that a further electrolysis device may then be converted more quickly from a rinsing mode to an optimum operation by setting the optimum process temperature. Furthermore, the use of the at least one temperature sensor is advantageous from the point of view of operational safety, since an overload of the at least two electrolysis devices is detected and corresponding protective mechanisms are triggered by means of the at least one actuator, in particular if there is a risk of thermal overload by the electrochemical process of electrolysis due to insufficient gas bubble detachment from the components wetted by the electrolyte and thus permanent damage to the system may be prevented. The advantage of using at least one temperature sensor is that this at least one temperature sensor is available as a cost-effective standard sensor with a high measuring accuracy. It may also be used for chemically relatively aggressive or problematic electrolytes. Any replacement of the at least one temperature sensor also has a cost advantage over other sensors for detecting the flow state.

According to a further embodiment, it is conceivable that at least one of the electrolysis devices comprises at least two electrolysis modules that are fluidically coupled with respect to the electrolyte stream. According to this embodiment, there is the advantage of possible adjustments to the electrolysis process within an electrolysis device due to a changeable electrical connection of the individual electrolysis modules while the electrolyte is guided through the electrolysis modules in a constant and/or unchanged manner. This means that the performance spectrum of an electrolysis system may be changed, which has far-reaching advantages, particularly with regard to the recurring optimization of the complete system in the event of changing framework conditions for the use of the system.

Furthermore, this design of the system makes it possible to achieve electrochemical compression and/or gas purification of hydrogen by lining up electrolysis modules within an electrolysis device. This is possible by a corresponding fluidic routing of the media within the electrolysis modules, wherein advantageously the electrolysis modules are fluidically connected in series within an electrolysis device and the at least two electrolysis devices may still be supplied as independently operable units from the common electrolyte supply device.

According to a further embodiment, it is conceivable that at least one of the at least two electrolysis modules comprises at least one anion-exchange membrane which divides a cell chamber of the at least one electrolysis module. An anion-exchange membrane as a charge-selective filter for separating anions from the electrolyte offers the decisive advantage of lower power densities compared to PEM electrolysers, for example, in terms of the complete system. The lower power density increases the safety of the complete system, as lower system pressures and temperature gradients prevail in the electrolyte stream and, at the same time, materials for components of electrolysis systems with anion-exchange membranes can be produced with comparatively fewer resources than, for example, materials for components of electrolysis systems with proton-exchange membranes. However, very thin anion-exchange membranes are used for an effective electrolysis process design, which makes sensitive monitoring and control of the electrolyte stream expedient. This problem is solved in a simple and effective manner by means of the at least one flow state detection device in combination with the at least one actuator for influencing the electrolyte stream, whereby a mutually interacting positive effect is achieved for a higher total efficiency of the system.

According to a particular embodiment, it is conceivable that the at least two electrolysis devices have different electrolysis modules with regard to the cell cross-section and/or with regard to a different number of cell chambers. A positive effect of this embodiment is the realization of different pressure levels of the electrolysis products. A further positive effect is that electrolysis modules connected in series in accordance with the process-related change in the properties of the electrolyte are matched to each other by adjusting the number of cells and cell size, wherein the effectiveness of an electrolysis device is increased. At the same time, this allows the at least two electrolysis devices to be matched to each other in terms of performance and with regard to the supply requirements for the electrolyte stream, which has the advantage that overall improved control of the system by the at least one actuator is possible with the aid of the detection values of the at least one flow state detection device.

Furthermore, it may be provided that the electrolyte supply device comprises a storage tank for the electrolyte and an electrolyte preparation device for the electrolyte, wherein the storage tank ensures the provision of the electrolyte for the at least two electrolysis devices. This embodiment allows the system to be operated as a closed system with regard to the electrolyte, which has the advantages of a closed enclosure in terms of system safety. Furthermore, this embodiment is advantageous because the electrolyte supply device with the one storage tank and corresponding auxiliary elements to ensure the supply, in particular pumps, may be designed redundantly. At the same time, the effect occurs that the regulation requirement of at least one actuator is covered by a corresponding dimensioning of the storage tank. Furthermore, the electrolyte preparation device ensures that the electrolyte in the storage tank is prepared in accordance with the process specifications while simultaneously being mixed in the storage tank, so that the flow state of the electrolyte stream may be optimally controlled by the actuator in accordance with the requirements of the electrolysis devices for the at least two electrolysis devices. As an extended synergy effect of this embodiment, the state monitoring for the electrolyte over several minutes or over several hours by means of the flow state detection device is used to estimate a necessary treatment of the electrolyte by means of the electrolyte treatment device and to trigger this necessary treatment centrally for the system by means of the control device.

In addition, it may be provided that the electrolyte supply device comprises a heat transfer device, wherein the heat transfer device is configured to supply or remove heat from the electrolyte. The heat transfer device as embodied has the advantage of a centralized, optimized preparation of the electrolyte. On the one hand, the heat transfer device thus enables the component protection of all components wetted with electrolyte within the system, and on the other hand, heat management has a positive effect on the flow state detection device in that a reference of the state of the electrolyte collected centrally in the storage tank corresponding to the detection values of the flow state detection device serves as a basis. This enables an even more precise adjustment of the electrolysis devices to the operating ranges of the at least two electrolysis devices by means of the at least one actuator. At the same time, the heat transfer device may also be used in cooperation with the electrolyte preparation device to prepare and condition the electrolyte.

In particular, it may be advantageous if the control device is configured to specify an operating range or an operating point for at least one of the electrolysis devices and to transmit it to the at least one electrolysis device for implementation. This results in the advantageous effect that the electrolyte supply device may be operated independently of the number and output of the at least two electrolysis devices and the at least one electrolysis device may be operated accordingly in an independent operating mode in the system.

According to a further embodiment, it is conceivable for the at least one electrolyte outlet to be flow-connected to the electrolyte supply device via at least one return line, so that a circulation of the electrolyte may be established between the electrolyte supply device and the at least one electrolysis device. According to this embodiment, it is ensured that components within one of the at least two electrolysis devices, which are wetted with the electrolyte, are protected from excessive stress, in particular if a malfunction of another of the at least two electrolysis devices occurs and there is a feedback of, for example, excessive pressures in the electrolyte stream caused by the malfunction. Furthermore, the amount of heat to be supplied to or removed from the at least one electrolysis device is positively influenced, since the electrolyte does not undergo any mixing due to the ensured circulation between the electrolyte supply device and the at least one electrolysis device. With regard to the flow state detection device, an optimum control of the at least one actuator is therefore possible.

Furthermore, it is useful if the electrolyte outlet of the at least one electrolysis device is flow-connected to the one storage tank for the electrolyte by means of the at least one return line. The fluidic connection of the at least one return line to the one storage tank ensures the defined return of the electrolyte, whereby an uncontrolled and/or unwanted influence on the electrolyte by fluid dynamics is excluded and the at least two electrolysis devices are optimally controlled by means of the at least one actuator in accordance with the requirements for the operating ranges of the at least two electrolysis devices.

Furthermore, it may be advantageous that the at least one electrolyte outlet can be coupled to the at least one return line by means of the at least one actuator. With regard to the electrolysis device, this measure has the decisive advantage that the electrolyte stream may be optimized with regard to the flow state via the at least one actuator, so that the electrolysis process is carried out in accordance with the requirements of the operating range of the electrolysis device. For example, a required pressure in the at least one electrolyte outlet may be set while simultaneously maintaining a required electrolyte stream through the electrolyte supply device.

In addition, it may be provided that the electrolyte stream through the at least one electrolysis device may be branched off or decoupled from a circulation line for the electrolyte by means of the at least one actuator. This has the advantageous effect that the supply of electrolyte may be provided by the electrolyte supply device regardless of the number and structural differences between the at least two electrolysis devices. Thus the electrolyte supply device can also be oversized in a redundant manner, which has no negative influence on the at least two electrolysis devices. Any supply elements for the electrolyte supply, such as pumps, can also be operated in an optimum operating range, since the circulation of electrolyte in the one circulation line may be decoupled from the supply situation of the at least two electrolysis devices by means of the at least one actuator. A further essential advantage of this design is that the system may now be expanded with additional electrolysis devices, wherein the electrolyte supply device may be operated up to a maximum possible electrolyte stream essentially independently of a gradual expansion.

An advantageous further embodiment of the system is characterized in that the at least one actuator connects an electrolyte inlet of the at least one electrolysis device to the circulation line. This design has the advantage that an actuator reacts directly to the supply situation of the at least one electrolysis device. This allows optimum reactions to load changes to be implemented by the at least one electrolysis device, which contributes to a higher total efficiency of the system, as the electrical supply power provided is utilized in an optimum manner. At the same time, flow accelerations and/or flow decelerations induced by any changes in the supply situation of the electrolyte supply device may be adjusted in a gradual manner, which increases the protection of the structural components and components in contact with the electrolyte of the at least one electrolysis device.

Another advantageous design is one in which the at least one actuator may be transferred to a blocking state in which an electrolyte stream to the at least one electrolysis device may be completely interrupted. In terms of operational safety, this has the advantage that the at least one electrolysis device connected downstream of the actuator in the direction of flow can be protected by the at least one actuator in the blocking state, or conversely that the system is protected in the event of a malfunction of the at least one electrolysis device. Furthermore, the automatically controllable or semi-automatically initiated blocking state makes it easy to replace and/or expand parts of the system even during continued operation of the electrolyte supply device.

In addition, it may be provided that the at least one actuator may be formed by a controllable throttle valve connected to the control device by wire, an electromagnetically actuated directional control valve, in particular a proportionally controlled directional control valve, or a changeover valve. An embodiment of the at least one actuator as a proportionally controlled directional control valve may be particularly advantageous, since correspondingly precise changes in the electrolyte current may be implemented, whereby the aforementioned effects of the at least one actuator are favored and can be implemented in a particularly favorable manner in accordance with the above-mentioned embodiments.

According to an advantageous further embodiment, it may be provided that the control device is configured to receive a target operating range for the system from a supply system for carrying out the electrolysis. It may be particularly advantageous if the supply system is a large system by means of which several systems for carrying out electrolysis are operated and supplied. This results in the advantageous effect that, with the aid of the detection values of the flow state detection device, the at least one actuator operates and/or protects the system for carrying out the electrolysis in an independent manner despite a specification for the target operating range. In particular, it may be advantageous that the control device is configured to transmit detection values of the at least one flow state detection device to a supply system. By transmitting the detection values in this way, it is possible to treat the components of the electrolysis system with care in an extended manner. For example, a feedback may be implemented using detection values for target operating range specifications, whereby a control loop is implemented with the supply system and the operation of the system for carrying out the electrolysis is carried out by means of the at least one actuator with regard to an ideal utilization of the system's capacities.

For the purpose of better understanding of the invention, this will be elucidated in more detail by means of the figures below. These show respectively in a very simplified schematic representation:

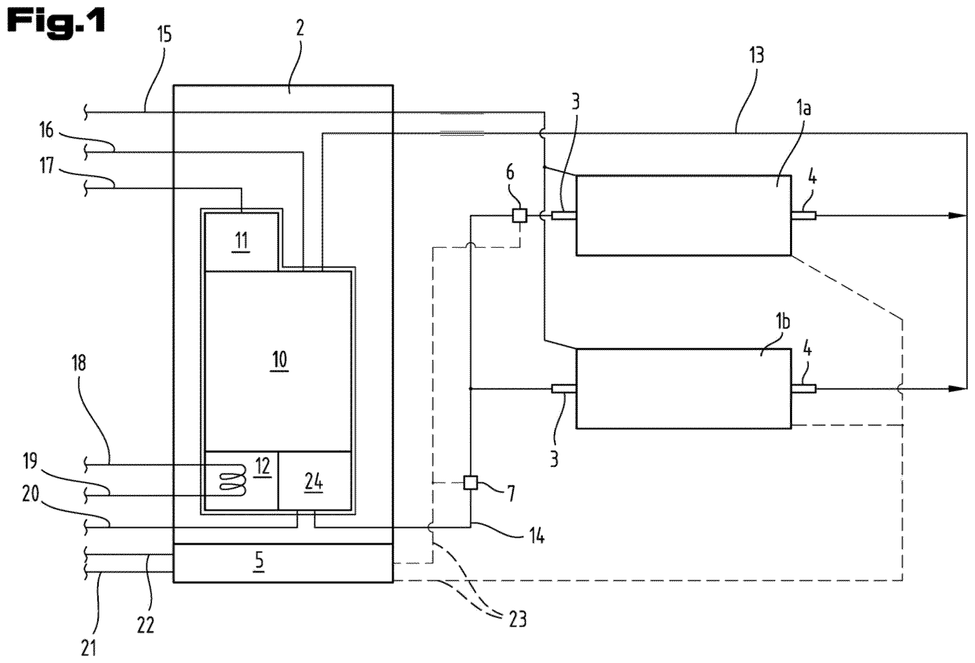

FIG. 1 a schematic representation of a system for carrying out electrolysis to produce oxygen and hydrogen in a first embodiment;

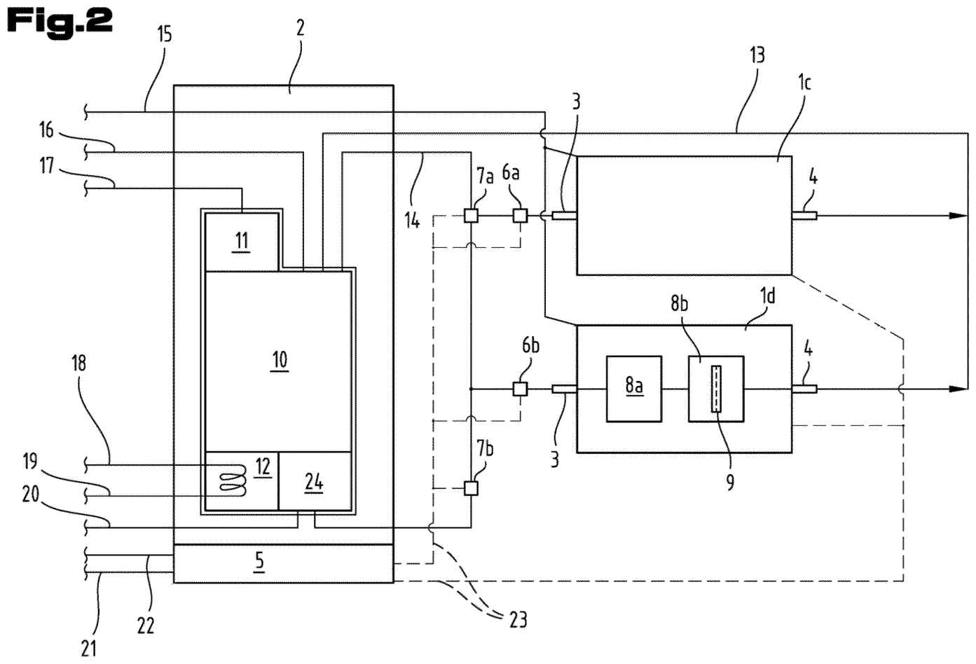

FIG. 2 a schematic representation of a system for carrying out electrolysis to produce oxygen and hydrogen in a second embodiment;

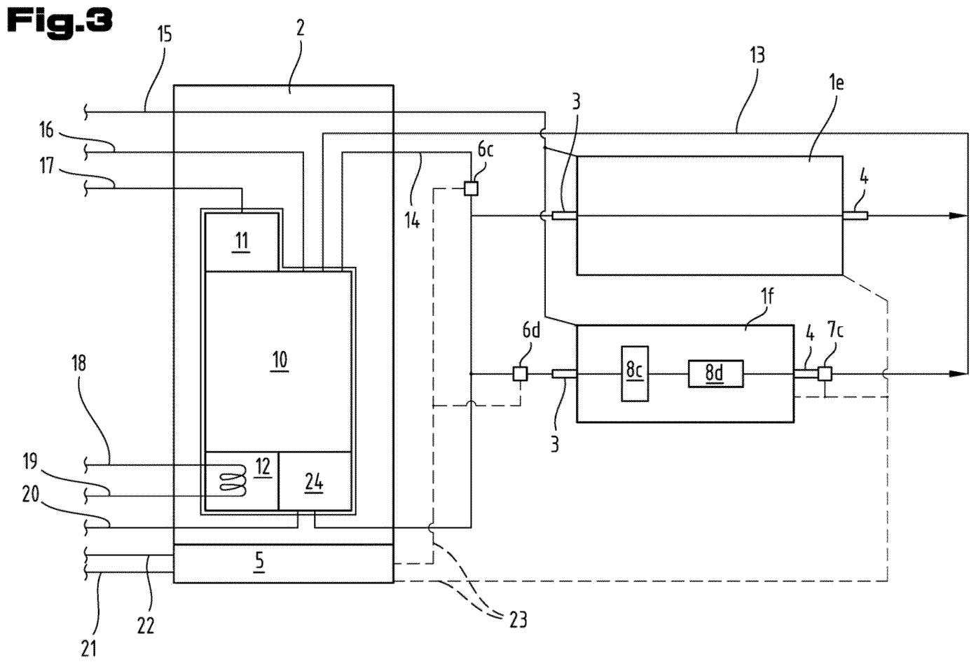

FIG. 3 a schematic representation of a system for carrying out electrolysis to produce oxygen and hydrogen in a third embodiment;

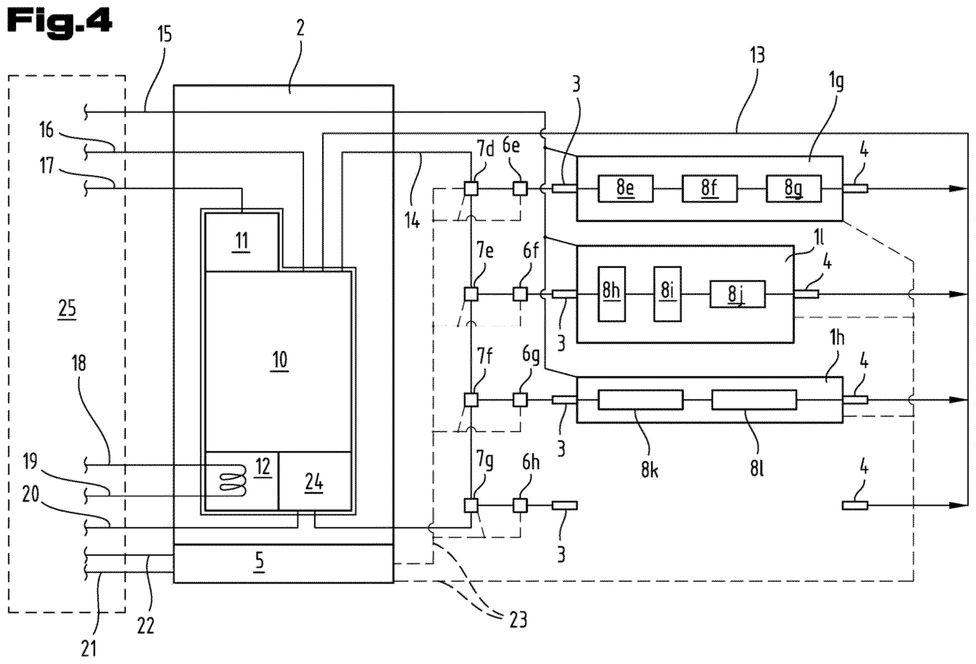

FIG. 4 a schematic representation of a plant for carrying out electrolysis to produce oxygen and hydrogen in a fourth embodiment.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 schematically shows a first possible embodiment of a system for carrying out electrolysis to produce oxygen and hydrogen. This system is configured to produce oxygen and hydrogen by means of an electrical load through the electrochemical process of electrolysis with the aid of an electrolyte, the primary purpose of the plant being the production of hydrogen for further use, storage or feeding into a corresponding infrastructure. The system shown may be operated independently or also within a large system as a semi-autonomous system. The system serves in any case the purpose of producing hydrogen, wherein the oxygen produced by the electrolysis process does not have to be intended for any specific further use. In particular, the system may be used to convert electrical power from renewable energies into so-called “green” hydrogen.

The illustrated embodiment of the system for carrying out electrolysis to produce oxygen and hydrogen comprises at least two electrolysis devices 1, in particular a first electrolysis device 1a and a second electrolysis device 1b, which are preferably of identical construction, although they do not necessarily have to be of identical construction. However, the use of several identical electrolysis devices 1 would would offer an economic advantage, as individual components can be produced in series at low cost. The electrolysis devices 1 may be supplied with an electrolyte from a common electrolyte supply device 2, wherein the electrolysis devices 1 each have an electrolyte inlet 3 and an electrolyte outlet 4. The respective electrolyte inlet 3 and the respective electrolyte outlet 4 are coupled to the common electrolyte supply device 2 so that an electrolyte stream may be established by the respective electrolysis device 1. This means that the electrolyte supply device 2 provides the electrolyte stream through the electrolysis devices 1, wherein the electrochemical process of electrolysis is carried out by the electrolysis device 1.

Furthermore, the illustrated embodiment of the system comprises at least one electronic control device 5 which controls the system. This electronic control device 5 may have a communication connection 21 and an electrical supply line 22. The electronic control device 5 can thus control the system in accordance with the specification of an operating range for the system and in accordance with the specification of an electrical load for the system. As mentioned above, this may be advantageous if the embodiments of the system shown are integrated as a sub-system within a large system, the large system providing corresponding specifications by means of the communication connection 21 and the electrical supply line 22.

Furthermore, the system comprises a flow state detection device 6 to detect the flow states of the electrolyte stream through at least one of the electrolysis devices 1. The control device 5 of the system is configured to control, on the basis of detection values of the at least one flow state detection device 6, at least one actuator 7 to influence the electrolyte stream through at least one of the electrolysis devices 1. For this purpose, there are corresponding control connections 23 between the control device 5 and the respective components of the system.

An electrolyte stream may thus be established in an advantageous manner in accordance with the operating ranges or operating points of the at least two electrolysis devices 1 built up, monitored by means of the at least one flow state detection device 6 and/or manipulated or influenced with regard to the process by means of the at least one actuator 7. The electrolyte thus provided in the electrolysis devices 1 is used to carry out electrolysis to produce oxygen and hydrogen with the aid of an electric load provided by one of the control connections 23 at one of the electrolysis devices 1. In accordance with the advantageous effects described above, this makes it possible to operate the system in an optimum manner, wherein it is also possible that the system carries out the electrolysis in accordance with the specifications of the communication connection 21 and the electrical supply line 22 in an inherently independent operation, but in connection with a large system.

According to the design of the system shown in FIG. 1, a product gas manifold 15 may be used to discharge the hydrogen produced from the electrolysis devices 1 for possible further use. The product gas manifold 15 may also provide the possibility to rinse the electrolysis devices 1 with fluid.

The electrolyte supply device 2 may comprise a storage tank 10 for the electrolyte and an electrolyte preparation device 11 for the electrolyte. The storage tank 10 may thus be used to guarantee the supply of electrolyte for the at least two electrolysis devices 1. It may also be provided that the at least one electrolyte outlet 4 is flow-connected via at least one return line 13 with the electrolyte supply device 2 so that a circulation of electrolyte may be established between the electrolyte supply device 2 and the at least one electrolysis device 1. In one possible embodiment of the system, the electrolyte may thus be returned via at least one return line 13 from the electrolysis devices 1 into the storage tank 10, since the electrolyte outlet 4 of the at least one electrolysis device 1 may be flow-connected with the one storage tank 10 for the electrolyte by means of the at least one return line 13. This makes it possible for the electrolyte to be fed back into the storage tank 10 from the electrolysis devices 1 and for the oxygen produced by the electrolysis to be discharged from the storage tank 10 tank by means of an oxygen line 16. Since electrolysis changes the chemical properties of the electrolyte, the electrolyte preparation device 11 may be used to prepare the electrolyte, wherein an appropriate additive supply line may be used 17.

Furthermore, the electrolyte supply device 2 may comprise a heat transfer device 12, wherein the heat transfer device 12 is configured to supply or remove heat from the electrolyte. This heat transfer device 12 may be used in accordance with the advantages described above. As a further advantageous additional function, the heat transfer device 12 may be used to make the preparation of the electrolyte by means of the electrolyte preparation device 11 more efficient. For example, by using the heat transfer device, the electrolyte 12 may be stimulated by heating to separate substances by evaporation, whereby the chemical properties of the electrolyte may be changed. Further advantageous effects of this embodiment are the component protection of the components wetted with electrolyte as well as the increase in the reaction speed of the electrolysis devices 1 and thus a more efficient operation of the same.

To ensure the functionality of the heat transfer device 12 and the storage tank 10, the system may be extended by a heat exchanger medium supply line 18 and a heat exchanger medium discharge line 19 and a storage tank drain line 20. This means that the heat transfer device 12 can be operated effectively with the aid of a heat exchanger medium. The storage tank 10 may also be completely emptied, for example to replace the electrolyte completely or to reprocess it externally. Furthermore, a possible embodiment is conceivable in which at least two storage tanks are used if a multi-flow operation with, for example, two electrolytes with different or the same chemical properties is used. With regard to this possible embodiment, it should be noted that further necessary structural measures, such as at least two electrolyte inlets and outlets, must be provided. With regard to the storage tank 10 a possible embodiment is also conceivable in which the additive supply line 17 as a multiple use may enable both the supply of the additive and any emptying of the storage tank 10.

This embodiment of the system, as shown in FIG. 1, enables an effective operation of the system, in particular since the control device 5 is configured to control the at least one actuator 7 on the basis of the detection values of the at least one flow state detection device 6 in such a way that each of the electrolysis devices 1 can be operated within its respectively predefined or respectively optimum volume flow operating range. The flow state detection device 6 may comprise at least one pressure sensor and/or one temperature sensor. As described above, the use of these sensors may be advantageous for the system due to several effects.

FIG. 2 shows a further and possibly independent embodiment of the system, wherein the same reference signs or component designations are used for the same parts as in the preceding FIG. 1. In order to avoid unnecessary repetition, reference is made to the detailed description of the preceding FIG. 1 and the preceding introduction to the description. As shown in FIG. 2, one possible design of the system may be that the electrolyte stream through the at least one electrolysis device 1c may be branched off/decoupled from a circulation line 14 for the electrolyte by means of the at least one actuator 7a. It may be provided that the at least one actuator 7a connects an electrolyte inlet 3 of the at least one electrolysis device 1c with the circulation line 14. In accordance with the effects described above, this design of the system has several advantages with regard to its operation. The system may also include a pumping device 24 for supplying the electrolysis devices 1 with electrolyte in a redundant manner. For the pumping device 24 it should be noted that this may be installed on the suction or pressure side with regard to the flow direction for supplying the electrolysis devices with electrolyte. As already described above, the circulation line 14 enables that the supply of electrolyte through the electrolyte supply device 2 may be provided regardless of the number and structural differences between the at least two electrolysis devices 1. For example, the pumping device 24 may also be oversized in order to allow an extension of the plant with several electrolysis devices 1 while at the same time meeting all the requirements of the electrolysis devices 1 to the electrolyte stream, particularly in terms of fluid dynamics. In the same way, the pumping device 24 may be extended by a pump for continuous circulation of the electrolyte. Such a design has the advantageous effect that the electrolyte stream is kept in constant motion, thus favorably reducing or preventing the accumulation of gas bubbles on surfaces wetted by the electrolyte.

It is also conceivable that, in a possible advantageous embodiment, the at least one actuator 7b is provided in the return of the circulation line. Thus, for example, knowing the internal resistances of the electrolysis devices 1 an ideal operating point of the at least two electrolysis devices 1 with regard to the efficiency of the same may be set. Above all, this may have far-reaching benefits in cooperation with an appropriate control of the pumping device 24, as it enables an extremely precise metering of the electrolyte stream. It should also be noted that the arrangement of the at least one actuator 7b shown in FIG. 2 is an example of an embodiment, so the possibility of arranging this actuator in the inlet of the circulation line may also be advantageous. It should also be noted at this point that the pumping device 24 may be designed for suction or pumping with regard to the direction of electrolyte supply and that no preferred arrangement is provided with regard to the direction of electrolyte supply. This is particularly important with regard to FIG. 1.

With regard to a structurally different design of the electrolysis devices 1 it may be provided that the different structural design of the electrolysis devices 1 results in a different operating range with regard to the electrical output of the electrolysis devices 1. Thus, as shown in FIG. 2, a further embodiment of the system may be advantageous in which at least one of the electrolysis devices 1 for example, as shown, the electrolysis device 1d, comprises at least two electrolysis modules 8 fluidically connected in series with respect to the electrolyte stream. This results in beneficial effects, as described above. It may also be advantageous for the different electrolysis modules 8 to be designed with regard to the cell cross-section and/or with regard to a different number of cell chambers, wherein at least one of the at least two electrolysis modules 8 comprises at least one anion-exchange membrane 9 which divides the cell chamber. In this way, the design of the system shown may create an increased degree of flexibility with regard to covering a wide operating range of the system. This may also create further advantageous properties of the system, such as treatment of the hydrogen gas with regard to its pressure level and purity within an electrolysis device 1. As an example, the possibility of treatment may be created by the described serial arrangement of the electrolysis modules 8 described above, wherein it is conceivable that an electrolysis module 8 also includes a plurality of anion-exchange membranes 9 which anion-exchange membranes 9 may thus carry out an electrolytic process in several cell chambers arranged in a row. Thus, the advantageous design may be created that within an electrolysis module 8 the path of the electrolyte and the path of the electrolysis products are designed in such a way that hydrogen gas may be produced with increased purity and pressure compared to an electrolysis with only one cell chamber.

FIG. 3 shows a further and possibly independent embodiment of the system, wherein the same reference signs or component designations are used for the same parts as in the preceding FIG. 1 and FIG. 2. In order to avoid unnecessary repetition, reference is made to the detailed description of the preceding FIG. 1 and FIG. 2 and the preceding introduction to the description. As shown in FIG. 3, one possible design of the system may be that the at least one electrolyte outlet 4 may be coupled to the at least one return line 7 by means of the at least one actuator 13. As already described, this advantageous design allows the electrolyte stream to be controlled effectively. As already mentioned in the introduction to the description and in FIG. 2, an advantageous design of the system, in particular of the electrolysis device 1f, may be that this electrolysis device 1f has at least two different electrolysis modules 8, in particular the electrolysis module 8c and the electrolysis module 8d, wherein these are fluidically connected in series. According to the schematic diagram, the electrolysis module 8c and the electrolysis module 8d may differ with regard to the cell cross-section and/or with regard to a different number of cell chambers. As already described in detail above, this possible design of the system may have several advantageous effects. On the one hand, the structural differences between the electrolysis modules 8 may correspond to different requirements for the electrolysis process. For example, different pressure levels and degrees of purity of the hydrogen gas may be realized by suitable serial arrangement of cell chambers with a first cell cross-section. On the other hand, with regard to the serial arrangement of the at least two electrolysis modules 8, a suitable adjustment of the number of cells and cell cross-section allows the second electrolysis module 8d in the serial arrangement to be operated in a high-performance manner, even if the electrolyte already may contain process-related gases from the first electrolysis module 8c. Furthermore, by suitably adjusting the number of cells and cell cross-sections of the at least two electrolysis modules 8 the operating range and/or the most effective operating point of the electrolysis device 1f may be optimally adapted to the requirements of the system, for example if the system is to be integrated into a large system as a sub-system with specific requirements. At this point, reference should also be made to the advantageous effects of the system according to the invention described above, with regard to optimum tuning on the basis of specifications of a variable electrical load on the part of a connected electrical grid and the resulting control capability of the system.

FIG. 4 shows a further and possibly independent embodiment of the system, wherein the same reference signs or component designations are used for the same parts as in the preceding FIG. 1, FIG. 2 and FIG. 3. In order to avoid unnecessary repetition, reference is made to the detailed description of the preceding FIG. 1, FIG. 2 and FIG. 3 and the preceding introduction to the description. As shown in FIG. 4, one possible design of the system may be that at least one actuator 7 may be transferred to a blocking state in which an electrolyte stream to the at least one electrolysis device 1 to which the at least one actuator 7 is assigned may be completely blocked. An example of such a possible embodiment is illustrated by the actuator 7f in FIG. 4. It is not possible to connect an electrolysis device 1 by means of an electrolyte inlet 3 to the electrolyte supply device 2 at this actuator 7f, wherein due to the blocking state of the actuator 7f the system according to the invention may continue to be operated in an optimum manner without restrictions. In addition to the advantageous effects already described, this may create the possibility of maintenance work or ensure the interchangeability of electrolysis devices 1 during continued operation, wherein the operating range of the system may continue to be kept in high-performance operation in accordance with the design of the system according to the invention.

Furthermore, the possible expansion form of the system in FIG. 4 shows the possibility of expanding the system according to the invention. For example, the system may comprise a plurality of electrolysis devices 1g, 1f and 1h, wherein these electrolysis devices 1 in turn each may comprise several and also structurally different electrolysis modules 8e to 8l. This possible constellation allows the system to be gradually and precisely adapted to operational requirements, while at the same time allowing expansion with additional electrolysis devices 1 up to the utilization limit of the electrolyte supply device 2 is not excluded. In addition to the advantages already described above, this schematically illustrated embodiment may be particularly advantageous if the disclosed system is operated in a semi-autonomous manner as part of a large system by means of a higher-level system that may take over control and load distribution tasks. This possible embodiment is indicated by the exemplary supply system 25 shown in FIG. 4. The supply system 25 may be provided by a large system as described.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions can be taken from the description.

According to the reference signs list terms from the reference signs list are used with and/or without a specific index in the description of the disclosure. If a precise differentiation of the terms with regard to their specific embodiment is not necessary, no indices are used. Conversely, for example, an electrolysis device 1g is differentiated from an electrolysis device 1f according to the respective description, wherein both are still electrolysis devices 1.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE SIGNS

1 electrolysis device
2 electrolyte supply device
3 electrolyte inlet
4 electrolyte outlet
5 control device
6 flow state detection device
7 actuator
8 electrolysis module
9 anion-exchange membrane
10 storage tank
11 electrolyte preparation device
12 heat transfer device
13 return line
14 circulation line
15 product gas manifold
16 oxygen line
17 additive supply line
18 heat exchanger medium supply line
19 heat exchanger medium discharge
20 line
storage tank drain line
21 communication connection
22 electrical supply line
23 control connections
24 pumping device
25 supply system

1. A system for carrying out electrolysis to produce oxygen and hydrogen, comprising
at least two electrolysis devices,
the electrolysis devices may be supplied with an electrolyte from a common electrolyte supply device,
the electrolysis devices each have at least one electrolyte inlet and an electrolyte outlet, the electrolyte inlets and electrolyte outlets are fluidically coupled to the common electrolyte supply device to provide an electrolyte stream through each of the electrolysis devices, and
at least one electronic control device,
wherein at least one flow state detection device is designed to detect the flow states of the electrolyte stream through at least one of the electrolysis devices, and
wherein the control device is designed to control at least one actuator to influence the electrolyte stream through at least one of the electrolysis devices using detection values from the at least one flow state detection devices.

2. The system according to claim 1, wherein the at least two electrolysis devices are structurally designed differently, with the different structural design of the electrolysis devices resulting in a different operating range with regard to the electrical output of the electrolysis devices.

3. The system according to claim 1, wherein the at least two electrolysis devices are fluidically connected in parallel with respect to their inflowing and outflowing electrolyte streams.

4. The system according to claim 1, wherein each of the electrolysis devices has a flow state detecting device for detecting the electrolyte stream through the individual electrolysis devices.

5. The system according to claim 1, wherein the control device is configured to control the at least one actuator using the detection values of the at least one flow state detection devices in such a way that each of the electrolysis devices is operated within its respective predefined volume flow operating range.

6. The system according to claim 1, wherein the flow state detection device comprises at least one pressure sensor.

7. The system according to claim 1, wherein the flow state detection device comprises at least one temperature sensor.

8. The system according to claim 1, wherein the at least one of the electrolysis devices comprises at least two electrolysis modules that are fluidically coupled to the electrolyte stream.

9. The system according to claim 8, wherein the at least one of the at least two electrolysis modules comprises at least one anion-exchange membrane which divides a cell chamber of the at least one electrolysis module.

10. The system according to claim 8, wherein the at least two electrolysis devices have different electrolysis modules with regard to a cell cross-section and/or with regard to a different number of cell chambers.

11. The system according to claim 1, wherein the electrolyte supply device comprises a storage tank for the electrolyte and an electrolyte preparation device for the electrolyte, wherein the storage tank ensures the provision of the electrolyte for the at least two electrolysis devices.

12. The system according to claim 1, wherein the electrolyte supply device comprises a heat transfer device, wherein the heat transfer device is configured to supply and/or remove heat from the electrolyte.

13. The system according to claim 1, wherein the control device is configured to specify an operating range or operating point for at least one of the electrolysis devices and to transmit it to the at least one electrolysis device for implementation.

14. The system according to claim 1, wherein the at least one electrolyte outlet is flow-connected via at least one return line with the electrolyte supply device, so that a circulation of electrolyte may be established between the electrolyte supply device and the at least one electrolysis device.

15. The system according to claim 14, wherein the electrolyte outlet of the at least one electrolysis device is flow-connected by means of the at least one return line with a storage tank for the electrolyte.

16. The system according to claim 14, wherein the at least one electrolyte outlet can be coupled to the at least one return line by the at least one actuator.

17. The system according to claim 1, wherein the electrolyte stream through the at least one electrolysis device may be branched off/decoupled from a circulation line for the electrolyte by the at least one actuator.

18. The system according to claim 17, wherein the at least one actuator connects an electrolyte inlet of the at least one electrolysis device with the circulation line.

19. The system according to claim 1, wherein the at least one actuator includes a blocking state in which an electrolyte stream to the at least one electrolysis device may be completely interrupted.

20. The system according to claim 1, wherein the at least one actuator includes one of a controllable throttle valve, an electromagnetically actuated directional control valve, a proportionally controlled directional control valve, or a changeover valve.

21. The system according to claim 1, wherein the control device is configured to receive a target operating range for the system from a supply system for carrying out the electrolysis from a supply system.

22. The system according to claim 1, wherein the control device is configured to transmit detection values of the at least one flow state detection device to a supply system.
